(19) United States
(12) Patent Application Publication
(10) Pub. No.: US 2026/0172285 A1
(43) Pub. Date: Jun. 18, 2026

(54) WIRELESS COMMUNICATION APPARATUS, OPERATING METHOD THEREOF, AND WIRELESS COMMUNICATION SYSTEM INCLUDING THE SAME

(71) Applicant: Samsung Electronics Co., Ltd., Suwon-si (KR)

(72) Inventors: Eunhye PARK, Suwon-si (KR); Hyoryun LEE, Suwon-si (KR); Hoon KANG, Suwon-si (KR)

(21) Appl. No.: 19/381,386

(22) Filed: Nov. 6, 2025

(30) Foreign Application Priority Data
Dec. 18, 2024 (KR) 10-2024-0190497

(51) Int. Cl. H04L 25/02; H04L 5/00

(52) U.S. Cl. CPC H04L 25/0202; H04L 5/0048

(57) ABSTRACT

A wireless communication apparatus includes a receiver configured to receive a pilot signal through a communication channel, and a processing circuit configured to determine a channel estimation value for the communication channel based on the received pilot signal, and the processing circuit is further configured to determine a symbol boundary and estimation data associated with a first group of symbols based on the first group of symbols included in the pilot signal, and determine the channel estimation value based on a second group of symbols included in the pilot signal and different from the first group of symbols, the symbol boundary, and the estimation data associated with the first group of symbols.

### CROSS-REFERENCE TO RELATED APPLICATION

This application claims priority to Korean Patent Application No. 10-2024-0190497, filed in the Korean Intellectual Property Office on Dec. 18, 2024, the entire disclosure of which is incorporated by reference herein its entirety.

### BACKGROUND

### 1. Technical Field

The present disclosure relates to a wireless communication apparatus, an operating method thereof, and a wireless communication system including the same.

### 2. Description of Related Art

Ultra-wideband (UWB) communication systems are attracting attention due to their ability to utilize a wide frequency band to provide high data transmission rates and short transmission times. The UWB communication system must comply with the maximum transmission power limit required by the regulatory body, which may impose constraints on transmission time or power level. In particular, in UWB communication, the channel characteristics may not be stable due to idle period between signals, resulting in a problem of lowered reliability of the channel estimation result.

The information described above is intended to improve understanding of the background of the present disclosure, and may not constitute the related art.

### SUMMARY

In order to address one or more problems (e.g., the problems described above and/or other problems not explicitly described herein), the present disclosure provides a wireless communication apparatus that achieves high channel estimation performance in a wireless communication system with an idle period between a synchronous signal and a pilot signal, an operating method thereof, and a wireless communication system including the same.

The object of the present invention is not limited thereto, and other objects not explicitly described herein may be clearly understood by those skilled in the art from the description of the present disclosure.

According to some aspects of the invention, a wireless communication apparatus may include a receiver configured to receive a pilot signal including a first group of symbols and a second group of symbols through a communication channel, and a processing circuit configured to determine a channel estimation value for the communication channel based on the received pilot signal, wherein the processing circuit is further configured to determine a symbol boundary and estimation data associated with the first group of symbols based on the first group of symbols, and determine the channel estimation value based on the second group of symbols, the symbol boundary, and the estimation data associated with the first group of symbols.

According to some aspects of the invention, an operating method of a wireless communication apparatus may include receiving a pilot signal including a first group of symbols and a second group of symbols through a communication channel, determining a symbol boundary and estimation data associated with the first group of symbols based on the first group of symbols, and determining a channel estimation value based on the second group of symbols, the symbol boundary, and the estimation data associated with the first group of symbols.

According to some aspects of the invention, a wireless communication system may include a first wireless communication apparatus configured to transmit a pilot signal, and a second wireless communication apparatus configured to receive the pilot signal and a synchronous signal associated with the pilot signal, wherein the second wireless communication apparatus comprises a receiver configured to receive the synchronous signal and the pilot signal through a communication channel, and a processing circuit configured to determine a channel estimation value for the communication channel based on the received pilot signal, wherein the receiver is further configured to receive the pilot signal after receiving the synchronous signal, with an idle period between the synchronous signal and the pilot signal, and wherein the processing circuit is further configured to determine a symbol boundary and estimation data associated with a first group of symbols based on the first group of symbols included in the pilot signal, and determine the channel estimation value based on a second group of symbols included in the pilot signal which is different from the first group of symbols, the symbol boundary, and the estimation data associated with the first group of symbols.

According to various aspects of the present disclosure, the accumulated sample signals may be generated by accumulating the sample signals included in the first group of symbols based on the sample indices, and the accumulated correlation values may be generated based on the generated accumulated sample signals and the ground truth sequence, so that computing resources can be efficiently utilized compared to when the correlation value is generated for each of the sample signals.

According to various aspects of the present disclosure, sample signals associated with the second group of symbols may be additionally accumulated in the first buffer where the sample signals associated with the first group of symbols are accumulated such that the accumulated sample signals associated with the pilot signal can be generated and the accumulated correlation values associated with the generated accumulated sample signals can be generated. Accordingly, since the channel estimation value can be determined based on the accumulated correlation values associated with the pilot signal which includes both the first group of symbols and the second group of symbols, the accuracy of channel estimation can be increased.

The effects that can be obtained through the present disclosure are not limited to those described above. Technical effects not explicitly described herein will be clearly understood by those skilled in the art from the description of the present disclosure described below.

### BRIEF DESCRIPTION OF THE DRAWINGS

The above and other objects, features and advantages of the present disclosure will become more apparent to those of ordinary skill in the art by describing in detail exemplary aspects thereof with reference to the accompanying drawings, in which:

FIG. 1 is a diagram provided to explain an example of a wireless communication system according to some aspects of the invention;

FIG. 2 is a block diagram illustrating an example of a wireless communication system according to some aspects of the invention;

FIG. 3 is a block diagram provided to explain an example of internal configurations of a wireless communication apparatus according to some aspects of the invention;

FIG. 4 is a diagram provided to explain an example of a communication method between a first wireless communication apparatus and a second wireless communication apparatus according to some aspects of the invention;

FIG. 5 is a diagram provided to explain an example of a method of a wireless communication apparatus for receiving a pilot signal according to some aspects of the invention;

FIG. 6 is a diagram provided to explain an example of a method of a wireless communication apparatus for receiving a pilot signal according to some aspects of the invention;

FIG. 7 is a flowchart provided to explain an operation of determining a symbol boundary and estimation data according to some aspects of the invention;

FIG. 8 is a flowchart provided to explain an operation of determining a symbol boundary and estimation data according to some aspects of the invention;

FIG. 9 is a flowchart provided to explain a method for accumulating sample signals in a first buffer according to some aspects of the invention;

FIG. 10 is a flowchart provided to explain an operation of performing channel estimation according to some aspects of the invention;

FIG. 11 is a flowchart provided to explain an operation of determining a symbol boundary and estimation data according to some aspects of the invention;

FIG. 12 is a flowchart provided to explain an operation of performing channel estimation according to some aspects of the invention; and

FIG. 13 is a conceptual diagram illustrating an IoT network system adopting some aspects of the invention.

### DETAILED DESCRIPTION

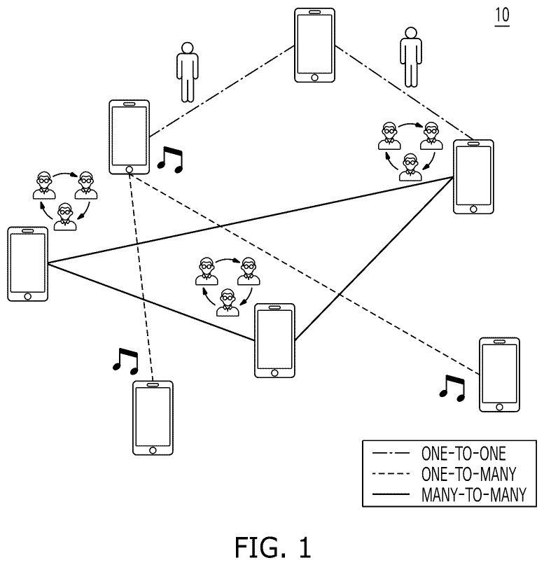

Various aspects of the present disclosure will be described with reference to FIGS. 1 to 13. Throughout the description, the same reference numerals may refer to the same components.

Throughout the specification, when a component is described as “including” a particular element or group of elements, it is to be understood that the component is formed of only the element or the group of elements, or the element or group of elements may be combined with additional elements to form the component, unless the context indicates otherwise.

It will be understood that, although the terms first, second etc. may be used herein to describe various elements, and/or component, these elements, and/or components should not be limited by these terms. Unless the context indicates otherwise, these terms are only used to distinguish one element, or component from another element or component. Thus, a first element, or component discussed below in one section of the specification could be termed a second element, or component in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

FIG. 1 is a diagram provided to explain an example of a wireless communication system 10 according to some aspects of the invention. Specifically, FIG. 1 illustrates an example of device-to-device (D2D) communication occurring in the wireless communication system 10.

As an example of the wireless communication system 10, a wireless personal area network (WPAN) may be formed in a relatively short radius (e.g., a radius in the range of about 10 meters). An example of WPAN may be ultra-wide band (UWB) which is a wireless communication technology that operates over a wide frequency range with low power consumption. It is used for high-speed data transmission, precise location tracking, and secure communication. UWB may use a wide frequency band of several GHz or more in a baseband state, a low spectral density, and a short pulse width, or a band to which the UWB communication is applied. The IEEE 802.15.4 standard defines the physical (PHY) layer and medium access control (MAC) sub-layer of UWB. The IEEE 802.15.4 standard defines high rate pulse repetition frequency UWB (IRP-UWB) and low rate pulse repetition frequency UWB (LRP-UWB), and IEEE 802.15.4z defines higher pulse repetition frequency UWB (HPRF-UWB) in HRP-UWB. UWB will be mainly described below as an example of the wireless communication system 10, but it is to be noted that the aspects of the present invention may be applied to other wireless communication technologies.

The D2D communication may refer to a method of direct communication between geographically close wireless communication apparatuses without involving use of infrastructure such as base stations. The D2D communication may use unlicensed frequency bands such as Wi-Fi Direct, Bluetooth, or may utilize licensed frequency bands to improve the frequency utilization efficiency of cellular systems. Throughout the description, the D2D communication may refer to communication between things and thing intelligence communication in the Internet of Things (IoT), as well as communication between wireless communication apparatuses.

As illustrated, wireless communication apparatuses included in the wireless communication system 10 may communicate with each other in various ways. For example, one wireless communication apparatus may communicate with another wireless communication apparatus in a one-to-one manner, as illustrated by a one-point chain in FIG. 1. In addition, as indicated by a dotted line in FIG. 1, one wireless communication apparatus may communicate with a number of other wireless communication apparatuses in a one-to-many manner. In addition, as illustrated by a solid line in FIG. 1, a number of wireless communication apparatuses may communicate with a number of other wireless communication apparatuses in a many-to-many manner.

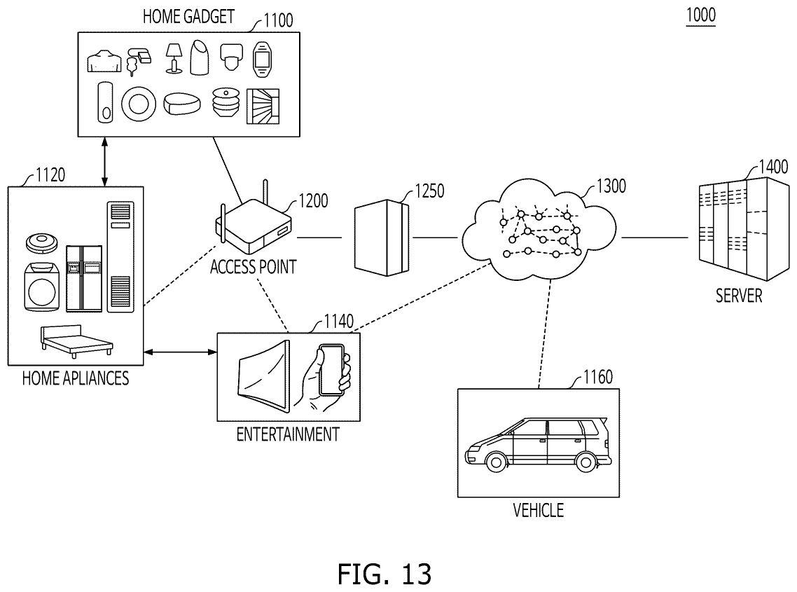

The wireless communication apparatus may be a portable device such as a mobile phone, a laptop computer, a wearable device, or a stationary device such as a desktop computer, a smart TV Other examples of the wireless communication apparatuses will be described below with reference to FIG. 13.

The wireless communication apparatus (e.g., a receiving side) may acquire synchronization based on a preamble of a signal received from another wireless communication apparatus (e.g., a transmitting side). For example, the wireless communication apparatus on the transmitting side may transmit a synchronous signal and/or a pilot signal for synchronization with the wireless communication apparatus on the receiving side. The synchronous signal and/or the pilot signal may have a structure already agreed in advance between the wireless communication apparatus on the transmitting side and the wireless communication apparatus on the receiving side. The wireless communication apparatus on the receiving side may perform channel estimation after completing time and frequency synchronization. If the time required for synchronization is delayed in the wireless communication apparatus on the receiving side or there is a time gap (e.g., idle period) between signals received for synchronization, the accuracy of channel estimation may decrease, and communication performance may be lowered.

Various functions described below may be implemented or supported by one or more computer programs, each of which may include a computer-readable program code and may be implemented in a computer-readable medium. The terms “application” and “program” may refer to one or more computer programs, software components, a set of instructions, procedures, functions, objects, classes, instances, related data, or some combination thereof suitable for the implementation of corresponding computer-readable program code. The “computer-readable program code” may include any type of computer code including source code, object code, and execution code. The “computer-readable medium” may include any type of medium that may be accessed by a computer, such as read only memory (ROM), random access memory (RAM), hard disk drive, compact disk (CD), digital video disk (DVD), or any other type of memory. Non-transitory computer-readable media, which may be storage devices that retain data even when power is removed, may exclude wired, wireless, optical, or other communication links that transmit transient electrical or other signals. The non-transitory computer-readable medium may include a medium on which data can be permanently stored, and a medium on which data can be stored and subsequently overwritten, such as a rewritable optical disk or an erasable memory device.

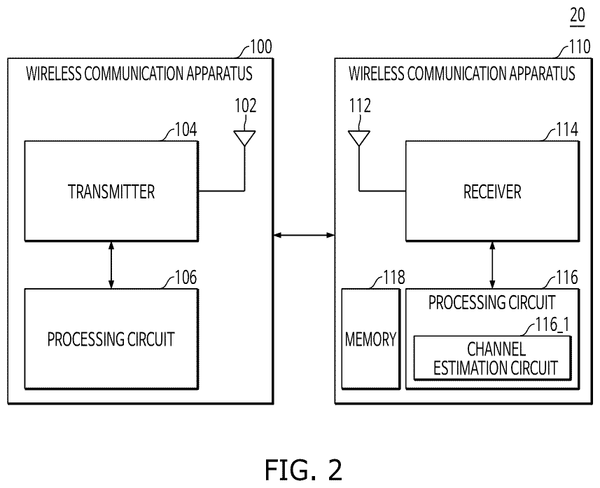

FIG. 2 is a block diagram illustrating an example of a wireless communication system 20 according to some aspects of the invention. Specifically, the block diagram of FIG. 2 may represent a first wireless communication apparatus 100 and a second wireless communication apparatus 110 communicating with each other in the wireless communication system 20. Each of the first wireless communication apparatus 100 and the second wireless communication apparatus 110 of FIG. 2 may be a device that is configured to communicate with another device in the wireless communication system 20, and may be a device for wireless communication.

As illustrated, the first wireless communication apparatus 100 may include an antenna 102, a transmitter 104, and a processing circuit 106. In some aspects, the antenna 102, the transmitter 104, and the processing circuit 106 may be included in one package or may be included in different packages, respectively. The processing circuit 106 may be a processor (i.e., a hardware circuit), such as a microprocessor, an application processor (AP), a digital signal processor (DSP), a field-programmable gate array (FPGA), etc. The processing circuit 106 may be formed by several interconnected processors and may be configured by software. The second wireless communication apparatus 110 may include an antenna 112, a receiver 114, a processing circuit 116, and a memory 118. Hereinafter, redundant descriptions of the first wireless communication apparatus 100 and the second wireless communication apparatus 110 will be omitted. In addition, certain aspect will be described below based on the assumption that the second wireless communication apparatus 110 receives a data signal from the first wireless communication apparatus 100, where the first wireless communication apparatus 100 may correspond to a transmission device, and the second wireless communication apparatus 110 may correspond to a receiving device.

The antenna 112 may receive a data signal including a pilot signal from the first wireless communication apparatus 100 and provide the data signal to the receiver 114. In some aspects, the antenna 112 may include a phased array for beamforming, in which the antenna 112 includes multiple antennas that work together to steer a beam of radio waves electronically without physically moving the antennas. The receiver 114 may process the data signal received through the antenna 112 and provide the result to the processing circuit 116. In some aspects, the receiver 114 may include analog circuits such as a low noise amplifier, a mixer, a filter, and a power amplifier.

The processing circuit 116 may include a channel estimation circuit 116_1. The channel estimation circuit 116_1 may perform a channel estimation to assess the characteristics of a transmission channel between the first wireless communication apparatus 100 and the second wireless communication apparatus 110. The channel estimation helps for the receiver 114 to compensate distortions in the transmission channel caused by factors like noise, interference, and signal fading. The channel estimation circuit 116_1 may receive a pilot signal from the receiver 114. The channel estimation circuit 116_1 may determine a channel estimation value for the communication channel on which the pilot signal is received.

The second wireless communication apparatus 110 may include the memory 118.

The processing circuit 116 may store the data signal received from the receiver 114 and/or estimation data determined from the data signal in the memory 118 or read out the data signal stored in the memory 118 and/or the estimation data from the memory 118.

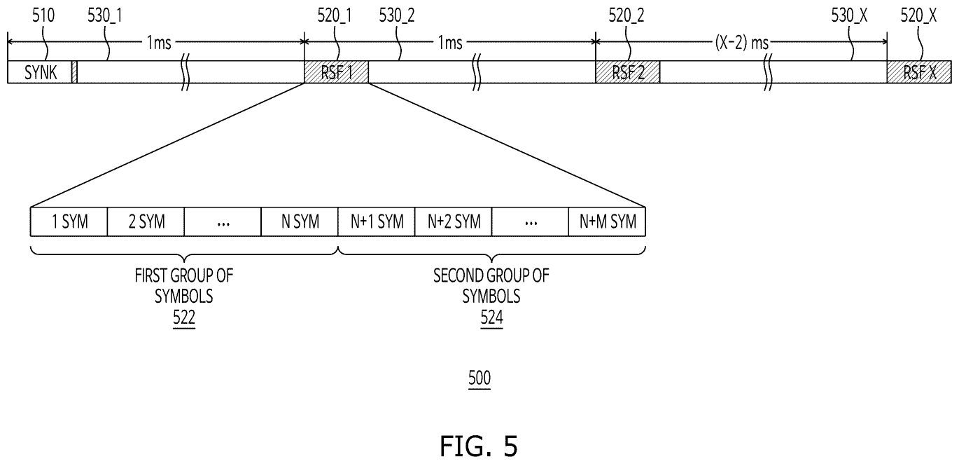

Throughout the description, in order to clarify the subject of operation according to some aspects, the processing circuit 116 is illustrated to include the channel estimation circuit 116_1, but the technical idea of the present invention is not limited thereto, and the operation of the channel estimation circuit 116_1 may be understood as the operation of the processing circuit 116. A detailed method for performing channel estimation by the second wireless communication apparatus 110 will be described in more detail below with reference to FIGS. 5 to 13.

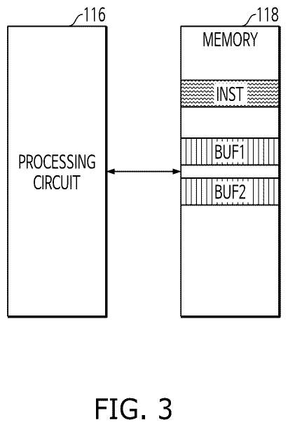

FIG. 3 is a block diagram provided to explain an example of internal configurations of a wireless communication apparatus according to some aspects of the invention. FIG. 3 may be a block diagram illustrating a partial internal configuration of the second wireless communication apparatus 110 of FIG. 2. As illustrated, the wireless communication apparatus may include the processing circuit 116 and the memory 118. The processing circuit 116 may access the memory 118, and the memory 118 may include a series of instructions INST, a first buffer BUF1, and a second buffer BUF2.

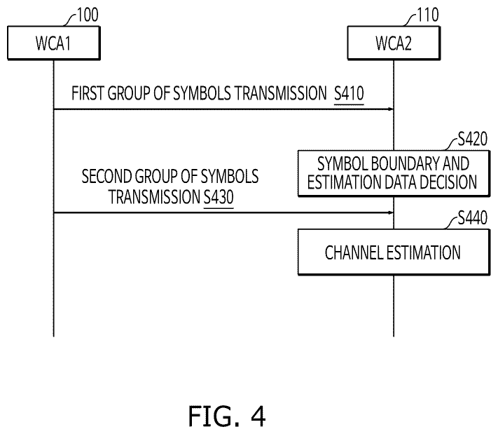

The processing circuit 116 may execute the series of instructions INST stored in the memory 118 to store or read the data in or from the memory 118. In some aspects, the processing circuit 116 may include a cache memory and may store the data read from the memory 118 in the cache memory or write the data stored in the cache memory to the memory 118. The data stored in or read from the memory 118 may include a sample signal or estimation data associated with the pilot signal received from the first wireless communication apparatus. A specific example of this will be described in detail below with reference to FIGS. 4 to 13.

The memory 118 may be any type of memory device that is accessible by the processing circuit 116. For example, the memory 118 may include a volatile memory device such as dynamic random access memory (DRAM), static random access memory (SRAM), or a non-volatile memory device such as flash memory. In some aspects, the memory 118 may include two or more memory devices, and the series of instructions INST, the first buffer BUF1, and the second buffer BUF2 may be stored in the two or more memory devices. For example, the series of instructions INST may be stored in a first memory device, and the first buffer BUF1 and the second buffer BUF2 may be implemented in a second memory device.

FIG. 4 is a diagram provided to explain an example of a communication method between the first wireless communication apparatus 100 and the second wireless communication apparatus 110 according to some aspects of the invention. Referring to FIG. 4, the second wireless communication apparatus 110 (e.g., the receiver of the second wireless communication apparatus 110) may receive a first group of symbols from the first wireless communication apparatus 100 through a communication channel at S410. The first group of symbols may refer to one or more symbols included in the pilot signal.

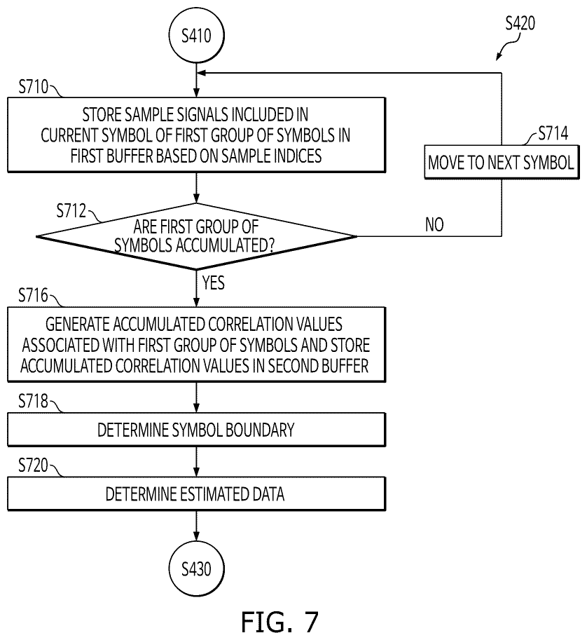

The second wireless communication apparatus 110 (e.g., the processing circuit of the second wireless communication apparatus 110) may determine a symbol boundary and estimation data associated with the first group of symbols based on the received first group of symbols at S420. The estimation data may include at least one of an initial phase offset associated with the first group of symbols, an initial frequency offset associated with the first group of symbols, or the number of symbols included in the first group of symbols. A method for determining the symbol boundary and the estimation data based on the first group of symbols will be described in more detail below with reference to FIGS. 7 to 11.

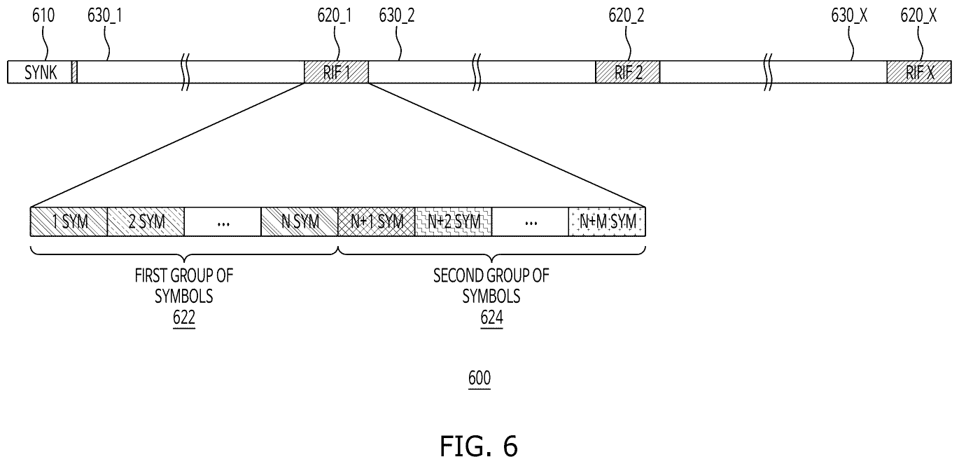

The second wireless communication apparatus 110 (e.g., the receiver of the second wireless communication apparatus 110) may receive a second group of symbols from the first wireless communication apparatus 100 through a communication channel at S430. The second group of symbols may be one or more symbols included in the pilot signal, and may follow the first group of symbols. Examples of the first group of symbols and the second group of symbols included in the pilot signal will be described in more detail below with reference to FIGS. 5 and 6.

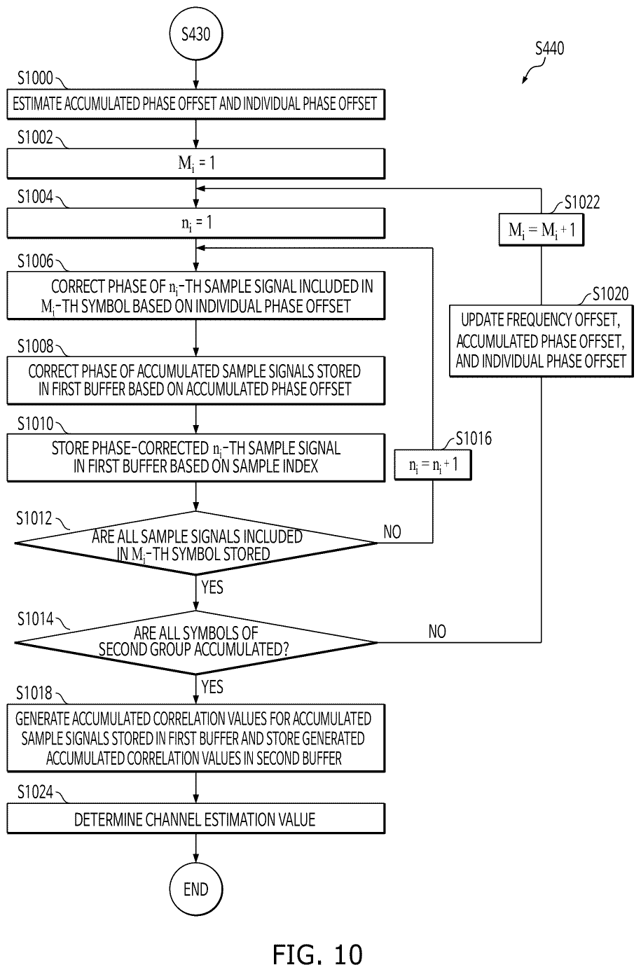

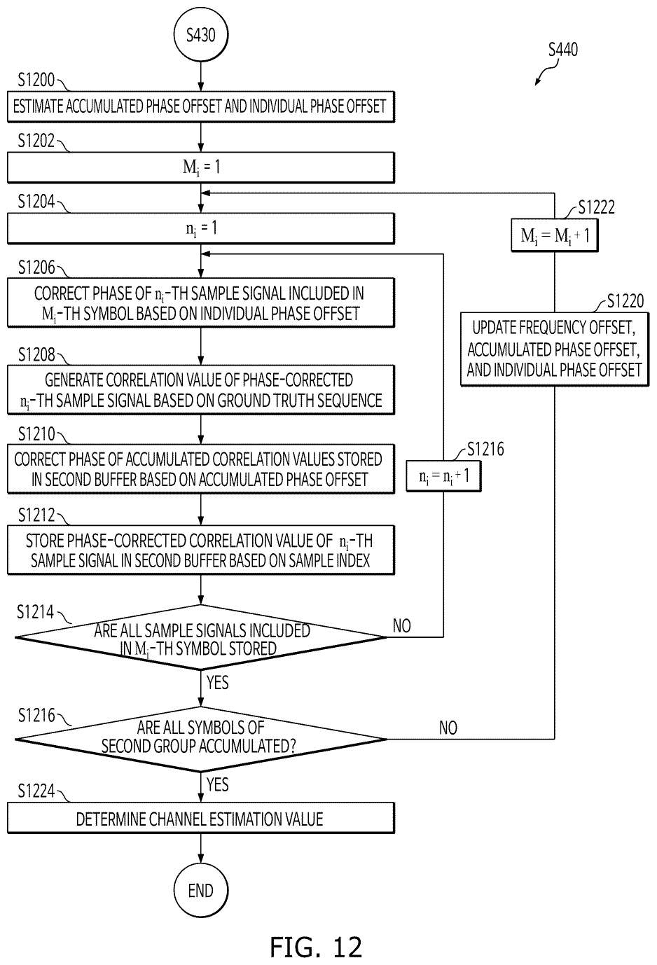

The second wireless communication apparatus 110 (e.g., the processing circuit of the second wireless communication apparatus 110) may perform channel estimation on the communication channel at S440. Specifically, the second wireless communication apparatus 110 may determine a channel estimation value for the communication channel on which the pilot signal is received, based on the symbol boundary and the estimation data determined based on the first group of symbols, and the second group of symbols. The determined channel estimation value may be used for estimating a location of the second wireless communication apparatus 110 or for estimating a distance between the first wireless communication apparatus 100 and the second wireless communication apparatus 110. As another example, the determined channel estimation value may be used for demodulation of the data received from the first wireless communication apparatus 100. A method for performing the channel estimation by the second wireless communication apparatus 110 will be described in more detail below with reference to FIGS. 10 and 12.

FIG. 4 illustrates that an operation S420 of determining a symbol boundary is performed after an operation S410 of receiving the first group of symbols is completed, but aspects of the present invention is not limited thereto. The operation S420 of determining the symbol boundary may be initiated simultaneously upon the reception of at least one sample signal included in the first group of symbols. In this case, the operation S410 of receiving the first group of symbols and the operation S420 of determining the symbol boundary may be performed at the same time. In addition, the operation S410 of receiving the first group of symbols and the operation S430 of receiving the second group of symbols may be performed successively, and accordingly, some operations may be performed at the same time.

FIGS. 5 and 6 are diagrams provided to explain an example of a method of the wireless communication apparatus for receiving a pilot signal according to some aspects of the invention. Specifically, FIGS. 5 and 6 are diagrams illustrating an example of a pilot signal for a UWB ranging operation in multi-millisecond (MMS). UWB MMS is a mode defined by IEEE 802.15.4ab and may refer to a wireless communication system that transmits a plurality of fragments/packets at regular intervals to improve link budget and time of flight (ToF) accuracy.

A plurality of fragments/packet may be used for UWB ranging (e.g., SS-TWR, DS-TWR, etc.). UWB communication systems may be required to comply with limits on the maximum transmission power specified by regulators to avoid causing unnecessary interference with other wireless communication systems. For example, in the UWB communication system, in order to comply with the maximum transmission power, the length of data that may be transmitted per transmission may be limited to 1 msec. In this case, the increase of the packet length due to the increase in data may cause a problem that the transmission power per pulse decreases in order to comply with the maximum transmission power. By adopting the UWB MMS communication system, data signals may be split into fragments/packet and transmitted while maintaining the interval between the fragments/packet within 1 msec. This ensures that the data signals are transmitted within the maximum transmission power.

Referring to FIGS. 5 and 6, the wireless communication apparatus may receive a synchronous signal SYNC. The synchronous signal SYNC may include synchronization information (e.g., SYNC field and Start Frame Delimiter (SFD) field) for triggering the transmission of the pilot signal. The pilot signal may be received in a fragment/packet form.

The synchronous signal SYNC may be received from the same device as the UWB communication device transmitting the pilot signal or from a separate narrow band (NB) communication device different from the UWB wireless communication apparatus transmitting the pilot signal.

Referring to FIG. 5, a plurality of pilot signals 520_1 to 520_X received by the wireless communication apparatus may be ranging sequence fragments (RSFs). The RSF may be configured in a pattern in which a plurality of predefined multi-millisecond ranging sequences (MMRS) structures are repeated.

Each of the plurality of pilot signals 520_1 to 520_X may include a plurality of symbols. The pilot signal 520_1 may include a first group of symbols 522 and a second group of symbols 524 that follows the first group of symbols 522. For example, the first group of symbols 522 may include N symbols (1 Sym to N Sym), and the second group of symbols 524 may include M symbols (N+1 Sym to N+M Sym).

The first group of symbols 522 may be used for determining a symbol boundary associated with the pilot signal 520_1. In addition, the first group of symbols 522 may be used for determining estimation data associated with the first group of symbols 522. Specifically, the wireless communication apparatus (e.g., the processing circuit of the wireless communication apparatus) may determine the symbol boundary and the estimation data associated with the pilot signal 520_1 based on the first group of symbols 522. The estimation data may include at least one of an initial phase offset associated with the first group of symbols 522, an initial frequency offset associated with the first group of symbols 522, or the number (e.g., N) of symbols included in the first group of symbols 522.

The second group of symbols 524 may be used for determining a channel estimation value for the communication channel on which the pilot signal 520_1 is received.

Specifically, the wireless communication apparatus may determine a channel estimation value based on the symbol boundary, the estimation data, which are determined based on the first group of symbols 522, and the second group of symbols.

The number of symbols included in each of the first group of symbols 522 and the second group of symbols 524 may be predetermined based on the system requirements (e.g., bandwidth, service type, etc.) of the wireless communication system or the data transmission structure. Alternatively, the number of symbols included in each of the first group of symbols 522 and the second group of symbols 524 may be adaptively changed based on the quality of the signal (e.g., signal-to-noise ratio (SNR) or signal-to-interference-plus-noise ratio (SINR), etc.) received through the communication channel or the estimation data. The number of symbols included in the first group of symbols 522 may be less than the number of symbols included in the second group of symbols 524, but the present invention is not limited thereto.

Each of the symbols included in the first group of symbols 522 and the second group of symbols 524 may be associated with the same ground truth sequence. A ground truth sequence may refer to a reference dataset used to evaluate the accuracy of a communication system. The ground truth sequence represents true and verified data against which estimations for the communication system are evaluated. The same ground truth sequence may refer to a reference dataset that remains consistent across multiple estimations. The same ground truth sequence ensures that different symbols are aligned with the same verified baseline for the evaluation. For example, the ground truth pilot signal corresponding to the pilot signal 520_1 received by the wireless communication apparatus may include a plurality of symbols, and each of the plurality of symbols included in the ground truth pilot signal may include a plurality of sample signals. In this case, all sequences of the sample signals included in each symbol of the plurality of symbols included in the ground truth pilot signal may be identical to one another. For example, the ground truth pilot signal may be configured to repeat a plurality of symbols that share the same ground truth sequence. In another example, a single ground truth sequence may be used for a plurality of symbols.

There may be an idle period 530_1 of a predetermined length of time between the synchronous signal SYNC and the first pilot signal 520_1. A length of the idle period 530_1 may be longer than a length of the synchronous signal SYNC. In addition, there may be the idle periods 530_2 to 530_X between the plurality of pilot signals 520_1 to 520_X, respectively. A length of each of the idle periods 530_2 to 530_X may be longer than a length of each of the plurality of pilot signals 520_1 to 520_X. For example, the length of each of the idle periods 530_2 to 530_X may be about 1 msec, and the length of the synchronous signal SYNC and/or the length of each of the plurality of pilot signals 520_1 to 520_X may be about 0.1 msec or less, but the present invention is not limited thereto.

Referring to FIG. 6, a plurality of pilot signals 620_1 to 620_X received by the wireless communication apparatus may be ranging integrity fragments (RIFs). Hereinafter, the description overlapping with that of FIG. 5 will be omitted.

Each of the plurality of pilot signals 620_1 to 620_X may include a plurality of symbols. The pilot signal 620_1 may include a first group of symbols 622 and a second group of symbols 624 that follows the first group of symbols 622. For example, the first group of symbols 622 may include N symbols (1 Sym to N Sym), and the second group of symbols 624 may include M symbols (N+1 Sym to N+M Sym). There may be the idle periods 630_1 to 630_X between the synchronous signal SYNC and the first pilot signal 620_1 and between the plurality of pilot signals 620_1 to 620_X.

The symbols included in the first group of symbols 622 and the second group of symbols 624 may be associated with ground truth sequences different from each other, respectively. For example, the ground truth pilot signal corresponding to the pilot signal 620_1 received by the wireless communication apparatus may include a plurality of symbols, and each of the plurality of symbols included in the ground truth pilot signal may include a plurality of sample signals. In this case, the sequences of the sample signals included in each of a plurality of symbols included in the ground truth pilot signal may be different from each other.

For example, the pilot signal 620_1 may include a scrambled timestamp sequence (STS), which is an encrypted sequence for increasing the integrity and accuracy of ranging measurement. Each of the plurality of pilot signals 620_1 to 620_X may include an STS.

FIG. 5 illustrates an example in which all of the plurality of pilot signals 520_1 to 520_X are RSFs, and FIG. 6 illustrates an example in which all of the plurality of pilot signals 620_1 to 620_X are RIFs, but the present invention is not limited thereto. For example, the wireless communication apparatus may receive a pilot signal that includes RSF during a first predetermined time period and RIF during a second predetermined time period.

Although FIGS. 5 and 6 illustrate that a plurality of pilot signals are transmitted with the idle periods of 530_1 to 530_X of 1 msec, the length of the idle periods 530_1 to 530_X is not limited to the specific length illustrated.

FIG. 7 is a flowchart provided to explain an operation S420 of determining a symbol boundary and estimation data according to some aspects of the invention. FIG. 7 is a flowchart provided to explain an aspect of the operation S420 of FIG. 4 in detail. Specifically, FIG. 7 illustrates an example of a method for determining the symbol boundary and the estimation data based on the pilot signals including the symbols (e.g., RSFs) associated with the same ground truth sequence.

The method for determining the symbol boundary and the estimation data may be performed by a processing circuit (e.g., the processing circuit of the wireless communication apparatus). The method for determining the symbol boundary and the estimation data may be performed after the operation (e.g., S410 of FIG. 4) of receiving the first group of symbols included in the pilot signal from the first wireless communication apparatus. Specifically, the method for determining the symbol boundary and the estimation data may be initiated by receiving at least one sample signal associated with the first group of symbols.

The processing circuit may store the sample signals included in the currently received symbol of the first group of symbols in the first buffer based on sample indices, at S710. For example, the processing circuit may store a plurality of sample signals included in the first symbol among the N symbols included in the first group of symbols (e.g., N is a natural number equal to or greater than two) in the first buffer based on the sample indices. The processing circuit may store the plurality of sample signals in the first buffer based on the sample indices. For example, the processing circuit may store each sample signal of the plurality of sample signals in connection with a corresponding sample index of the first buffer. When each symbol of the first group of symbols includes n-number of sample signals (e.g., n is a natural number equal to or greater than two), the first buffer may include n-number of sample indices for storing the n-number of sample signals as corresponding sample indices respectively. For example, the first sample signal among the n-number of sample signals may be stored in first sample index, the second sample signal among the n-number of sample signals is stored in second sample index, and the n-th sample signal among the n-number of sample signals is stored in n-th sample index.

The processing circuit may determine whether all of the plurality of sample signals included in the first group of symbols are accumulated in the first buffer, at S712. In response to determining that all of the plurality of samples included in the N symbols of the first group of symbols are not accumulated (i.e., NO in S712), the processing circuit may perform a task on the next symbol included in the first group of symbols, at S714. For example, the processing circuit may store a plurality of sample signals included in the second symbol among the N symbols included in the first group of symbols in the first buffer based on the sample indices, at S710.

The processing circuit may determine whether all of the plurality of sample signals included in the N symbols of the first group of symbols are accumulated in the first buffer, at S712. The operations S712, S714, and S710 described above may be repeatedly performed until it is determined that all of the plurality of sample signals included in the first group of symbols are accumulated in the first buffer.

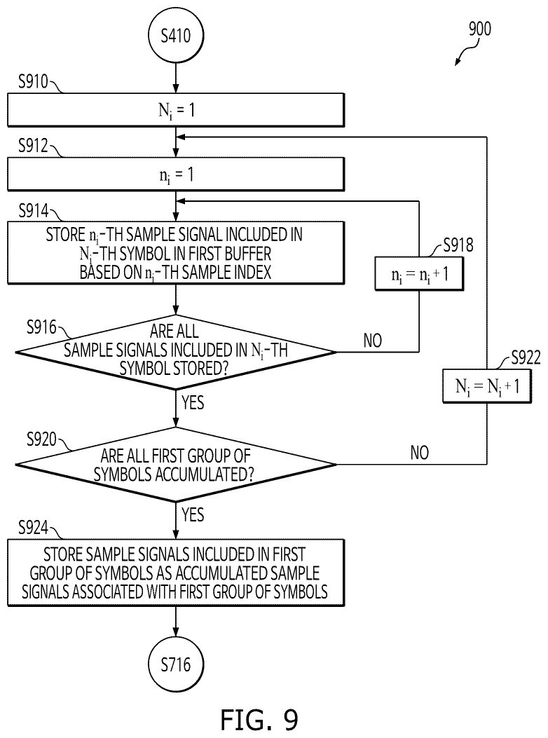

Upon determining that all of the plurality of samples included in the first group of symbols are accumulated (YES in S712), the processing circuit may generate accumulated correlation values associated with the first group of symbols and store the accumulated correlation values in the second buffer, at S716. Specifically, the processing circuit may accumulate the sample signals included in the first group of symbols based on the sample indices through S710, S712, and S714 and thus store the accumulated sample signals associated with the first group of symbols in the first buffer. In addition, the processing circuit may generate the accumulated correlation values associated with the first group of symbols based on the accumulated sample signals associated with the stored first group of symbols and on the ground truth sequence, and store the accumulated correlation values in the second buffer based on sample indices. For example, the processing circuit may store the accumulated correlation values in corresponding sample indices of the second buffer. A number of the accumulated correlation values to be stored in the second buffer may be n (e.g., n is a natural number equal to or greater than two). The second buffer may include n-number of sample indices for storing the accumulated correlation values in corresponding sample indices of the second buffer. For example, the first accumulated correlation value among the n-number of the accumulated correlation values may be stored in first sample index of the second buffer, the second accumulated correlation value among the n-number of the accumulated correlation values is stored in second sample index of the second buffer, and the n-th accumulated correlation value among the n-number of accumulated correlation values is stored in n-th sample index of the second buffer. An example of a method for accumulating the sample signals included in the first group of symbols based on the sample indices will be described in more detail below with reference to FIG. 9.

The processing circuit may determine a symbol boundary and estimation data associated with the first group of symbols based on the accumulated correlation values associated with the first group of symbols stored in the second buffer, at S718 and S720. The estimation data associated with the first group of symbols may include at least one of an initial phase offset associated with the first group of symbols, an initial frequency offset associated with the first group of symbols, or the number of symbols included in the first group of symbols.

Alternatively, the processing circuit may determine the symbol boundary and the estimation data associated with the first group of symbols based on the accumulated sample signals associated with the first group of symbols stored in the first buffer, at S718 and S720. For example, the processing circuit may determine the symbol boundary and the estimation data associated with the first group of symbols based on at least one of the accumulated correlation values associated with the first group of symbols stored in the second buffer or the accumulated sample signals associated with the first group of symbols stored in the first buffer. If the symbol boundary and the estimation data are determined by using both the accumulated sample signals associated with the first group of symbols and the accumulated correlation values associated with the first group of symbols, accuracy may be increased.

With this configuration, the accumulated sample signals may be generated by accumulating the sample signals included in the first group of symbols based on the sample indices, and the accumulated correlation values may be generated based on the accumulated sample signals and the ground truth sequence. Because the accumulated correlation values are generated based on the accumulated sample signals and the ground truth sequence, computing resources can be utilized more efficiently than when the correlation value is generated for each of the sample signals separately.

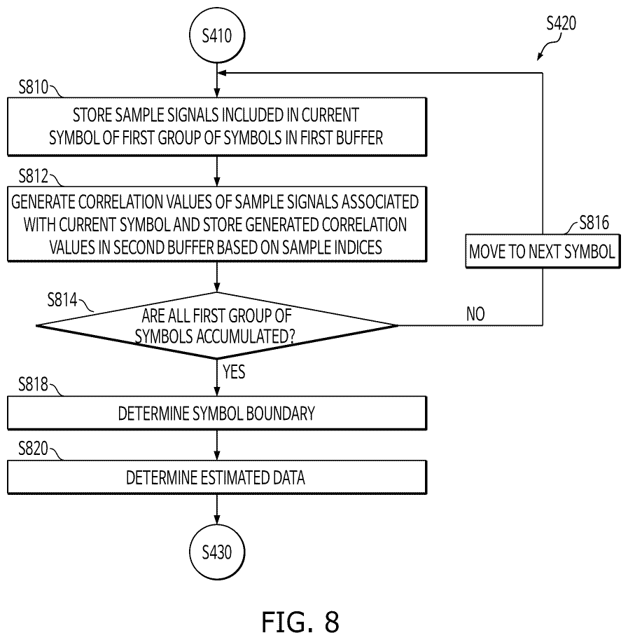

FIG. 8 is a flowchart provided to explain the operation S420 of determining the symbol boundary and the estimation data according to some aspects of the invention. FIG. 8 is a flowchart provided to explain another aspect of the operation S420 of FIG. 4 in detail. Specifically, FIG. 8 illustrates another example of the method for determining the symbol boundary and the estimation data based on the pilot signals including the symbols (e.g., RSFs) associated with the same ground truth sequence. In FIG. 8, a configuration different from the configuration described in FIG. 7 will be mainly described.

The processing circuit (e.g., the processing circuit of the wireless communication apparatus) may store the sample signals included in the currently received symbol of the first group of symbols in the first buffer, at S810. For example, the processing circuit may store a plurality of sample signals included in the first symbol For example, the first symbol among the N symbols may be included in the first group of symbols (e.g., N is a natural number equal to or greater than two) in the first buffer.

For each of the sample signals associated with the current symbol (e.g., the first symbol), the processing circuit may generate correlation values of the sample signals associated with the current symbol and store the generated correlation values in the second buffer based on the sample indices, at S812.

The processing circuit may determine whether all of the plurality of sample signals included in the first group of symbols are accumulated in the first buffer, at S814. Upon determining that all of the plurality of sample signals included in the first group of symbols are not accumulated (NO in S814), the processing circuit may repeat accumulating the plurality of sample signals on the next symbol included in the first group of symbols, at S816. For example, the processing circuit may store, in the first buffer, a plurality of sample signals included in the second symbol among the N symbols included in the first group of symbols, and generate correlation values of the sample signals associated with the second symbol and store the correlation values in the second buffer based on the sample indices, at S810 and S812. At this time, as the correlation values of the sample signals associated with the first symbol and the correlation values of the sample signals associated with the second symbol are stored in the second buffer based on the sample indices, the correlation values of the sample signals with the same sample indices may be stored (or accumulated) in association with each other. For example, a correlation value of a first sample signal associated with the first symbol and a correlation value of a first sample signal associated with the second symbol may be correlated and stored in the second buffer. Likewise, a correlation value of a second sample signal associated with the first symbol and a correlation value of a second sample signal associated with the second symbol may be correlated, accumulated, and stored in the second buffer.

The processing circuit may determine whether all of the plurality of sample signals included in the first group of symbols are accumulated in the first buffer, at S814. Upon determining that all of the plurality of samples included in the first group of symbols are accumulated (YES in S814), the processing circuit may determine the symbol boundary and the estimation data associated with the first group of symbols based on the accumulated correlation values which are generated by accumulating the correlation values and stored in the second buffer, at S818 and S820.

FIG. 9 is a flowchart provided to explain a method 900 for accumulating the sample signals in the first buffer according to some aspects of the invention. FIG. 9 is a flowchart provided to explain operations S710, S712, and S714 of FIG. 7 in detail. Specifically, FIG. 9 illustrates an example in which the sample signals included in the first group of symbols are accumulated based on the sample indices, thereby storing the accumulated sample signals associated with the first group of symbols in the first buffer.

The wireless communication apparatus (e.g., the receiver of the wireless communication apparatus) may receive a pilot signal through a communication channel. The pilot signal may include a first group of symbols and a second group of symbols that follows the first group of symbols. Each of the first group of symbols and the second group of symbols may include a plurality of sample signals associated with the same ground truth sequence. For convenience of explanation, it is assumed that the first group of symbols includes N symbols (e.g., N is a natural number equal to or greater than 2), and that each symbol includes n sample signals (e.g., n is a natural number equal to or greater than 2).

The method 900 may be initiated by the wireless communication apparatus receiving a first sample signal of a first symbol among the first group of symbols, at S910 and S912. For example, the wireless communication apparatus may receive the first sample signal (e.g., Nᵢ=1, nᵢ=1) of the first symbol of the first group of symbols.

The processing circuit (e.g., the processing circuit of the wireless communication apparatus) may store the first sample signal of the first symbol (e.g., Nᵢ=1, nᵢ=1) in the first buffer based on the first sample index, at S914. The processing circuit may determine whether all the sample signals (e.g., Nᵢ=1, nᵢ=1 to n) included in the first symbol are stored, and if it is determined that all the sample signals (e.g., Nᵢ=1, nᵢ=1 to n) included in the first symbol are not stored (e.g., NO in S916), the processing circuit may repeat storing next sample signal of the first symbol. For example, a second sample signal (e.g., Nᵢ=1, nᵢ=2) received after the first sample signal (e.g., Nᵢ=1, nᵢ=1) of the first symbol may be stored in the first buffer based on the second sample index, at S916, S918, and S914. The operations S916, S918, and S914 described above may be repeatedly performed until it is determined that all the sample signals (e.g., Nᵢ=1, nᵢ=1 to n) included in the first symbol are stored in the first buffer.

Upon determining that all the sample signals included in the first symbol are stored (YES in S916), the processing circuit may determine whether all of the sample signals for the N symbols included in the first group of symbols are accumulated, at S916 and S920. Upon determining that all the sample signals included in the first group of symbols are not accumulated (NO in S920), the processing circuit may may repeat storing sample signals on the next symbol (e.g., a second symbol), at S920 and S922.

For example, the processing circuit may store a first sample signal (e.g., Nᵢ=2, nᵢ=1) included in the second symbol of the first group of symbols in the first buffer based on the first sample index, at S914. In this case, the first sample signal (e.g., Nᵢ=1, nᵢ=1) included in the first symbol and the first sample signal (e.g., Nᵢ=2, nᵢ=1) included in the second symbol may be stored in the first buffer based on the first sample index. For example, the first sample signal (e.g., Nᵢ=1, nᵢ=1) included in the first symbol and the first sample signal (e.g., Nᵢ=2, nᵢ=1) included in the second symbol may be accumulated and added based on the same sample index.

The operations S916, S918, and S914 described above may be repeatedly performed until it is determined that all the sample signals (e.g., Nᵢ=2, nᵢ=1 to n) included in the second symbol are stored in the first buffer. In addition, the operations S920 and S922 described above may be repeatedly performed until it is determined that all the sample signals included in the first group of symbols (e.g., Nᵢ=1 to N) are accumulated in the first buffer.

Upon determining that all the sample signals included in all symbols included in the first group of symbols are accumulated in the first buffer (YES in S920), the processing circuit may store and specify, in the first buffer, the sample signals included in the first group of symbols as accumulated sample signals associated with the first group of symbols, at S924. For example, for the accumulated sample signals associated with the first group of symbols, the first sample signals (e.g., Nᵢ=1 to N, nᵢ=1) of the first to Nth symbols may be accumulated and added based on the first sample index, the second sample signals (e.g., Nᵢ=1 to N, nᵢ=2) of the first to Nth symbols may be accumulated and added based on the second sample index, and the Nth sample signals (e.g., Nᵢ=1 to N, nᵢ=n) of the first to Nth symbols may be accumulated and added based on the nth sample index.

FIG. 10 is a flowchart provided to explain the operation S440 of performing channel estimation according to some aspects of the invention. FIG. 10 is a flowchart provided to explain an aspect of operation S440 of FIG. 4 in detail. Specifically, FIG. 10 illustrates an example of a method for determining a channel estimation value based on pilot signals including symbols (e.g., RSFs) associated with the same ground truth sequence.

The wireless communication apparatus (e.g., the receiver of the wireless communication apparatus) may receive a pilot signal through a communication channel. The pilot signal may include a first group of symbols and a second group of symbols that follows the first group of symbols. For convenience of explanation, it is assumed that the second group of symbols includes M symbols (e.g., M is a natural number equal to or greater than 2), and that each symbol includes n sample signals (e.g., n is a natural number equal to or greater than 2).

The operation S440 of determining the channel estimation value may be initiated after the operation S430 of receiving the second group of symbols by the wireless communication apparatus (e.g., 110 of FIG. 4). Alternatively, the operation S440 of determining the channel estimation value may be initiated simultaneously with the operation S430 of receiving the second group of symbols by the wireless communication apparatus (e.g., 110 in FIG. 4) or before the operation S430 of receiving the second group of symbols. For example, the operation S440 of determining the channel estimation value may be initiated immediately after the operation S420 of FIG. 4 of determining the estimation data associated with the symbol boundary and the first group of symbols.

The processing circuit (e.g., the processing circuit of the wireless communication apparatus) may estimate an accumulated phase offset associated with the first group of symbols and an individual phase offset for each of the second group of symbols, based on the estimation data associated with the first group of symbols, at S1000. The estimation data associated with the first group of symbols may include an initial phase offset associated with the first group of symbols, an initial frequency offset associated with the first group of symbols, or the number of symbols included in the first group of symbols.

The accumulated phase offset may be expressed by Mathematical Expression 1 below, and the individual phase offset may be expressed by Mathematical Expression 2 below.

$${θ}_{1} = \{ \begin{matrix}0 , & {M}_{i} = 0 \\ {\hat{θ}}_{init} + π {\hat{f}}_{0} {N}_{samp} \cdot ( {\hat{N}}_{acc} - 1 ) , & {M}_{i} = 1 \\ 0 , & {M}_{i} > 1\end{matrix} \qquad 〈 Mathematical Expression 1 〉$$

$${θ}_{2} = \{ \begin{matrix}0 , & {M}_{i} = 0 \\ {\hat{θ}}_{init} + 2 π {\hat{f}}_{0} {N}_{samp} \cdot ( {\hat{N}}_{acc} - 1 ) , & {M}_{i} = 1\end{matrix} \qquad 〈 Mathematical Expression 2 〉$$

where, θ₁ may denote the accumulated phase offset, θ₂ may denote the individual phase offset, \hat{θ}ᵢₙᵢₜ may denote the initial phase offset associated with the first group of symbols, \hat{f}₀ may denote the initial frequency offset associated with the first group of symbols, Nₛₐₘₚ may denote the number of sample signals included in one symbol, \hat{N}_{acc} may denote the number of sample signals included in the first group of symbols, and Mᵢ may denote the symbol index for the symbols included in the second group of symbols.

The wireless communication apparatus may receive the first sample signal of the first symbol among the second group of symbols, at S1002 and S1004. For example, the wireless communication apparatus may receive the first sample signal (e.g., Mᵢ=1, nᵢ=1) of the first symbol of the second group of symbols. The processing circuit may correct the phase of the first sample signal (e.g., Mᵢ=1, nᵢ=1) of the first symbol included in the second group of symbols based on the estimated individual phase offset, at S1006. In addition, the processing circuit may correct the phases of the accumulated sample signals stored in the first buffer based on the estimated accumulated phase offset, at S1008. In this case, the accumulated sample signals stored in the first buffer may be the accumulated sample signals associated with the first group of symbols. Additionally, the first sample signal (e.g., Mᵢ=1, nᵢ=1) of the first symbol which is phase-corrected based on the individual phase offset may be accumulated and stored in the first buffer based on the first sample index, at S1010. For example, the accumulated sample signals that are phase-corrected based on the accumulated phase offset, and the first sample signal (e.g., Mᵢ=1, nᵢ=1) of the first symbol that is phase-corrected based on the individual phase offset may be accumulated and added based on the first sample index.

The accumulated sample signal may be updated by accumulating and adding the phase-corrected accumulated sample signal based on the individual phase offset to the phase-corrected sample signal based on the accumulated phase offset. The accumulated sample signal stored in the first buffer after the update may be expressed by Mathematical Expression 3 as follows.

$$InputBuf [ {n}_{i} ] = InputBuf [ {n}_{i} ] \cdot exp ( - j \cdot {θ}_{1} ) + In \cdot exp ( - j \cdot {θ}_{2} ) , \qquad 〈 Mathematical Expression 3 〉$$

where, InputBuf[n] on the left side may denote the accumulated sample signals stored in the first buffer after the update, InputBuf [n] on the right side may denote the accumulated sample signals stored in the first buffer before the update, In may denote the sample signal (or the currently received sample signal) which is the sample signal included in the second group of symbols and is to be phase-corrected, and nᵢ may denote the sample index of the sample signal currently being processed.

The processing circuit may determine whether all of the sample signals (e.g., Mᵢ=1, nᵢ=1 to n) included in the first symbol of the second group of symbols are stored in the first buffer, at S1012. Upon determining that all of the sample signals (e.g., Mᵢ=1, nᵢ=1 to n) included in the first symbol of the second group of symbols are not stored in the first buffer (NO in S1012), the processing circuit may repeat accumulating and adding the next sample signal included in the first symbol to the accumulated sample signals stored in the first buffer, at S1016, S1006, S1008, S1010, and S1012. Specifically, the wireless communication apparatus may correct the phase of the second sample signal (e.g., Mᵢ=1, nᵢ=2), received after the first sample signal (e.g., Mᵢ=1, nᵢ=1) of the first symbol of the second group of symbols, based on the individual phase offset, at S1006. In addition, the processing circuit may correct the phases of the accumulated sample signals stored in the first buffer based on the accumulated phase offset, at S1008. The accumulated sample signals stored in the first buffer may include the accumulated sample signals associated with the first group of symbols and the first sample signals (e.g., Mᵢ=1, nᵢ=1) of the first symbol associated with the second group of symbols, which are accumulated and added. Additionally, the second sample signal (e.g., Mᵢ=1, nᵢ=2) of the first symbol which is phase-corrected based on the individual phase offset may be accumulated and stored in the first buffer based on the second sample index, at S1010. The operations S1012, S1016, S1006, S1008, and S1010 described above may be repeatedly performed until it is determined that all the sample signals (e.g., Mᵢ=1, nᵢ=1 to n) included in the first symbol are stored in the first buffer.

Upon determining that all the sample signals (e.g., Mᵢ=1, nᵢ=1 to n) included in the first symbol of the second group are stored in the first buffer (YES in S1012), the processing circuit may determine whether all the sample signals associated with the second group of symbols are accumulated, at S1014. Upon determining that all the sample signals included in the second group of symbols are not accumulated (NO in S1014), the processing circuit may update the frequency offset, the accumulated phase offset, and the individual phase offset, and repeat updating the frequency offset, the accumulated phase offset, and the individual phase offset on the next symbol (e.g., the second symbol), at S1020, S1022, etc.

The frequency offset may be newly estimated and updated for each symbol of the second group of symbols, but the present invention is not limited thereto. Although FIG. 10 illustrates that the frequency offset is updated for each symbol of the second group of symbols, the frequency offset may be newly estimated and updated for every few symbols of the second group of symbols or for a predetermined number of sample signals in the symbols. The accumulated phase offset and the individual phase offset may be updated based on the frequency offset.

If the frequency offset is updated for each symbol, the accumulated phase offset updated based on the updated frequency offset may be expressed by Mathematical Expression 4 below, and the individual phase offset may be expressed by Mathematical Expression 5 below.

$${θ}_{1} = \{ \begin{matrix}{θ}_{1} + 2 π {\hat{f}}_{0} , & for {M}_{i} = 1 \\ {θ}_{1} + 2 π ( {\hat{f}}_{{M}_{i}} - {\hat{f}}_{{M}_{i} - 1} ) , & for {M}_{i} > 1\end{matrix} \qquad 〈 Mathematical Expression 4 〉$$

$${θ}_{2} = {θ}_{2} + 2 π {\hat{f}}_{{M}_{i}} , for all {M}_{i} \geq 1 \qquad 〈 Mathematical Expression 5 〉$$

where, θ₁ on the left side may denote the accumulated phase offset after update, θ₁ on the right side may denote the accumulated phase offset before update, \hat{f}₀ may denote the initial frequency offset associated with the first group of symbols, Mᵢ may denote the symbol index for symbols included in the second group of symbols, and \hat{f}_{M}_{ᵢ} may denote the Mᵢ-th estimated frequency offset.

In addition, in Mathematical Expression 5, θ₂ on the left side may denote the individual phase offset before update, and θ₂ on the right side may denote the individual phase offset after update.

The processing circuit may repeat operations S1006, S1008, S1020 and S1012 on the first sample signal (e.g., Mᵢ=2, nᵢ=1) of the second symbol that is received after the first symbol, at S1004. The processing circuit may correct the phase of the first sample signal (e.g., Mᵢ=2, nᵢ=1) of the second symbol based on the individual phase offset updated at S1020, at S1006. In addition, the processing circuit may correct the phases of the accumulated sample signals stored in the first buffer based on the accumulated phase offset updated at S1020, at S1008. Additionally, the processing circuit may store the first sample signal (e.g., Mᵢ=2, nᵢ=1) of the second symbol phase-corrected based on the individual phase offset in the first buffer based on the sample index, and determine whether all the sample signals (e.g., Mᵢ=2, nᵢ=1 to n) included in the second symbol are stored in the first buffer, at S1010 and S1012.

The operations S1016, S1006, and S1008, S1010, and S1012 described above may be repeatedly performed until it is determined that all the sample signals (e.g., Mᵢ=2, nᵢ=1 to n) included in the second symbol are stored in the first buffer.

In addition, Upon determining that all the sample signals (e.g., Mᵢ=2, nᵢ=1 to n) included in the second symbol are stored in the first buffer (YES in S1010), the processing circuit may determine whether all the sample signals associated with the second group of symbols are accumulated in the first buffer, at S1014. The operations S1014, S1020, and S1022 described above may be repeatedly performed until it is determined that sample signals included in all symbols (e.g., Mᵢ=1 to M) of the second group are accumulated in the first buffer. Accordingly, all the sample signals associated with the first group and all the sample signals associated with the second group may be accumulated based on the sample indices in the first buffer to form accumulated sample signals.

Upon determining that all the sample signals associated with the second group of symbols are accumulated in the first buffer (YES in S1014), the processing circuit may generate accumulated correlation values for the accumulated sample signals stored in the first buffer based on the ground truth sequence, and store the accumulated correlation values in the second buffer, at S1018.

The processing circuit may determine a channel estimation value based on the accumulated correlation value stored in the second buffer, at S1024. The channel estimation value may include a Channel Impulse Response (CIR) value for the communication channel. In addition, the CIR value may be calculated separately, based on the determined symbol boundary, into a first CIR value associated with the sample signals received before the symbol boundary and a second CIR value associated with the sample signals received after the symbol boundary. For example, the CIR value may be represented by Mathematical Expression 6 below.

$$CIR [ {k}^{*} : Nsamp - {k}^{*} ] = corrBuf [ 0 : Nsamp - {k}^{*} - 1 ] \qquad 〈 Mathematical Expression 6 〉$$

$$CIR [ 0 : {k}^{*} - 1 ] = corrBuf [ Nsamp - {k}^{*} + 0 : Nsamp - 1 ]$$

where, Nₛₐₘₚ may denote the number of sample signals included in one symbol, k* may denote the determined symbol boundary, and corrBuf[ ] may denote the accumulated correlation values stored in the second buffer.

With this configuration, the sample signals associated with the second group of symbols may be additionally accumulated in the first buffer where the sample signals associated with the first group of symbols are accumulated such that the accumulated sample signals associated with the pilot signal may be generated, and the accumulated correlation values associated with the generated accumulated sample signals may be generated. Since the channel estimation value may be determined based on the accumulated correlation values associated with the pilot signal which includes both the first group of symbols and the second group of symbols, the accuracy of channel estimation can be increased.

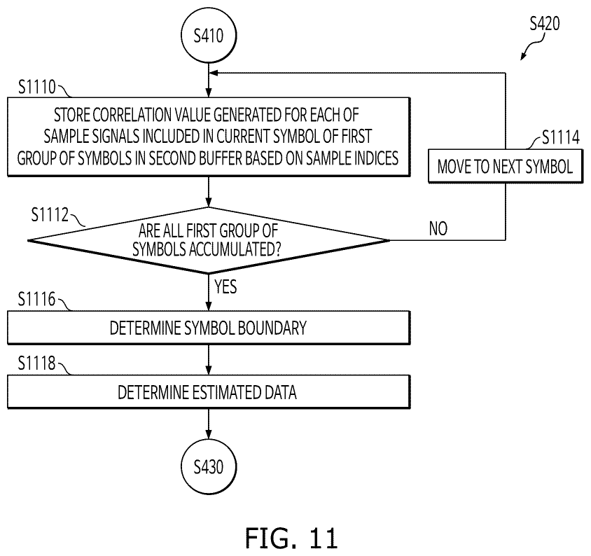

FIG. 11 is a flowchart provided to explain the operation S420 of determining the symbol boundary and the estimation data according to some aspects of the invention. FIG. 11 is a flowchart provided to explain in detail the operation S420 of FIG. 4 according to other aspects of the invention. Specifically, FIG. 11 illustrates an example of the method for determining the symbol boundary and the estimation data based on the pilot signals including symbols (e.g., RIFs) associated with different ground truth sequences. The different ground truth sequence refers to a reference dataset that varies across multiple estimations. Unlike the same ground truth sequence, the different ground truth sequence allows diversity in estimations for the communication system by introducing variability for broader signal processing. In FIG. 11, a configuration different from the configuration described in FIGS. 7 to 9 will be mainly described.

First, the processing circuit (e.g., the processing circuit of the wireless communication apparatus) may store a correlation value generated for each of the sample signals included in the current symbol of the first group of symbols included in the pilot signal in the second buffer based on the sample indices, at S1110. For example, the processing circuit may store the correlation value generated for each of the sample signals included in the first symbol. For example, the correlation value for the first symbol among the N symbols included in the first group of symbols (e.g., N is s natural number equal to or greater than two), may be stored in the second buffer based on the sample indices. More specifically, each time the sample signal is received, the processing circuit may generate the correlation value based on the corresponding sample signal and the ground truth sequence, and store the generated correlation value in the second buffer.

The processing circuit may determine whether the correlation values for each of all the sample signals associated with the first group of symbols are accumulated in the second buffer, at S1112. Upon determining that all the correlation values associated with the first group of symbols are not accumulated in the second buffer (NO in S1112), the processing circuit may repeat storing the correlation values on the next symbol (e.g., the second symbol), at S1114 and S1110. The processing circuit may repeatedly perform the operations S1112, S1114, and S1110 described above until it is determined that the accumulated correlation values generated by accumulating all the correlation values associated with the first group of symbols are stored in the second buffer.

The processing circuit may determine a symbol boundary and estimation data associated with the first group of symbols based on the accumulated correlation values associated with the first group of symbols stored in the second buffer, at S1116 and S1118.

FIG. 12 is a flowchart provided to explain the operation S440 of performing channel estimation according to some aspects of the invention. FIG. 12 is a flowchart provided to explain in detail the operation S440 of FIG. 4 according to other aspects of the invention. Specifically, FIG. 12 illustrates an example of a method for determining a channel estimation value based on a pilot signal including symbols (e.g., RIFs) associated with different ground truth sequences. In FIG. 12, a configuration different from the configuration described in FIG. 10 will be mainly described.

The wireless communication apparatus (e.g., the receiver of the wireless communication apparatus) may receive a pilot signal through a communication channel. The pilot signal may include a first group of symbols and a second group of symbols that follows the first group of symbols. For convenience of explanation, it is assumed that the second group of symbols includes M symbols (e.g., N is a natural number equal to or greater than 2), and that each symbol includes n sample signals (e.g., n is a natural number equal to or greater than 2).

The operation S440 of determining the channel estimation value may be initiated after the operation S430 of receiving the second group of symbols by the wireless communication apparatus (e.g., 110 of FIG. 4). The processing circuit (e.g., the processing circuit of the wireless communication apparatus) may estimate an accumulated phase offset associated with the first group of symbols and an individual phase offset for each of the second group of symbols, based on the estimation data associated with the first group of symbols, at S1200. In this case, the accumulated correlation values associated with the first group of symbols may be stored in the second buffer in advance.

The wireless communication apparatus may receive the first sample signal of the first symbol among the second group of symbols, at S1202 and S1204. For example, the wireless communication apparatus may receive the first sample signal (e.g., Mᵢ=1, nᵢ=1) of the first symbol of the second group of symbols. The processing circuit may correct the phase of the first sample signal (e.g., Mᵢ=1, nᵢ=1) of the first symbol included in the second group of symbols based on the estimated individual phase offset, at S1206. In addition, the processing circuit may generate a correlation value of the first sample signal (e.g., Mᵢ=1, nᵢ=1) of the phase-corrected first symbol based on the ground truth sequence, at S1208. Additionally, based on the estimated accumulated phase offset, the processing circuit may correct the phases of the accumulated correlation values stored in the second buffer and store the phase-corrected correlation values of the first sample signal (e.g., Mᵢ=1, nᵢ=1) of the first symbol in the second buffer based on the sample index, at S1210 and S1212. The processing circuit may determine whether the correlation values for all the sample signals included in the first symbol of the second group of symbols are accumulated in the second buffer, at S1214.

The processing circuit may repeatedly perform the operations S1214, S1216, S1206, S1208, S1210, and S1212 described above until the correlation values for all the sample signals included in the first symbol of the second group of symbols are stored in the second buffer. Upon determining that the correlation values for all the sample signals included in the first symbol are stored in the second buffer (YES in S1214), the processing circuit may determine whether the correlation values associated with all symbols (e.g., Mᵢ=1 to M) of the second group are accumulated in the second buffer, at S1218. If the correlation values associated with all symbols of the second group (e.g., Mᵢ=1 to M) are not accumulated in the second buffer (NO in S1218), the processing circuit may update the frequency offset, the accumulated phase offset, and the individual phase offset at symbol intervals and repeat updating the frequency offset, the accumulated phase offset, and the individual phase offset associated with the next symbol (e.g., Mᵢ=2), at S1220, S1222, etc. The processing circuit may repeatedly perform the operations S1218, S1220, S1222, etc. described above until the accumulated correlation values (i.e., all the correlation values for the second group of symbols stored in the second buffer) are generated.

The processing circuit may determine a channel estimation value based on the accumulated correlation values stored in the second buffer, at S1224. The channel estimation value may include a Channel Impulse Response (CIR) value for the communication channel.

The flowcharts of FIGS. 7 to 12 and the above description are merely examples, and some aspects may be differently implemented. For example, in some aspects, the order of each operation may be changed, some operations may be performed at the same time, some may be repeatedly performed, or some may be added, omitted, and changed. Additionally or alternatively, at least some of the operations may be performed by a different entity.

FIG. 13 is a conceptual diagram illustrating an IoT network system 1000 to which some aspects of the present disclosure are applied.

Referring to FIG. 13, the IoT network system 1000 may include a plurality of IoT devices 1100, 1120, 1140, and 1160, an access point 1200, a gateway 1250, a wireless network 1300, and a server 1400. Internet of Things (IoT) may refer to a network of interconnected objects using wired/wireless communication.

Each of the IoT devices 1100, 1120, 1140, and 1160 may be grouped according to the characteristics of each IoT device. For example, the IoT devices may be grouped into a home gadget group 1100, a home appliance/furniture group 1120, an entertainment group 1140, a vehicle group 1160, etc. The plurality of IoT devices 1100, 1120, and 1140 may be connected to a communication network or other IoT devices through the access point 1200. The access point 1200 may be embedded in a single IoT device. The gateway 1250 may change the protocol to allow the access point 1200 to connect to an external wireless network. The IoT devices 1100, 1120, and 1140 may be connected to an external communication network through the gateway 1250. The wireless network 1300 may include the Internet and/or a public network. The plurality of IoT devices 1100, 1120, 1140, and 1160 may be connected to the server 1400 that provides a predetermined service through the wireless network 1300, and user may use the service through at least one of the plurality of IoT devices 1100, 1120, 1140, and 1160.

According to some aspects, the plurality of IoT devices 1100, 1120, 1140, and 1160 may perform the channel estimation operation according to the aspects described with reference to FIGS. 1 to 12. Accordingly, the IoT devices 1100, 1120, 1140, and 1160 may perform efficient and effective communication to provide high-quality services to the users.

What is claimed is:

1. A wireless communication apparatus, comprising:
a receiver configured to receive a pilot signal including a first group of symbols and a second group of symbols through a communication channel; and
a processing circuit configured to determine a channel estimation value for the communication channel based on the received pilot signal,
wherein the processing circuit is further configured to:
determine a symbol boundary and estimation data associated with the first group of symbols based on the first group of symbols; and
determine the channel estimation value based on the second group of symbols, the symbol boundary, and the estimation data associated with the first group of symbols.

2. The wireless communication apparatus according to claim 1, further comprising:
a first buffer configured to store sample signals associated with the first group of symbols; and
a second buffer configured to store accumulated correlation values associated with the first group of symbols.

3. The wireless communication apparatus according to claim 2, wherein the processing circuit is further configured to generate the estimation data associated with the first group of symbols based on the accumulated correlation values associated with the first group of symbols stored in the second buffer, and the estimation data comprises at least one of an initial phase offset associated with the first group of symbols, an initial frequency offset associated with the first group of symbols, or the number of symbols included in the first group of symbols.

4. The wireless communication apparatus according to claim 2, wherein each symbol included in the first group of symbols and the second group of symbols is associated with a first ground truth sequence, and the processing circuit is further configured to store accumulated sample signals associated with the first group of symbols in the first buffer, in which the accumulated sample signals are generated by accumulating sample signals included in the first group of symbols of the pilot signal with sample signals stored in the first buffer based on sample indices.

5. The wireless communication apparatus according to claim 4, wherein the processing circuit is further configured to generate the accumulated correlation values associated with the first group of symbols based on the accumulated sample signals associated with the first group of symbols stored in the first buffer and the ground truth sequence, and store the accumulated correlation values in the second buffer.

6. The wireless communication apparatus according to claim 4, wherein the processing circuit is further configured to:
estimate an accumulated phase offset associated with the first group of symbols based on the estimation data associated with the first group of symbols; and
correct a phase of the accumulated sample signals associated with the first group of symbols stored in the first buffer based on the estimated accumulated phase offset.

7. The wireless communication apparatus according to claim 4, wherein the processing circuit is further configured to:
estimate an individual phase offset for each of the second group of symbols based on the estimation data;
correct a phase of each sample signal included in the second group of symbols based on the individual phase offset; and
store accumulated sample signals associated with the pilot signal in the first buffer, in which the accumulated sample signals are generated by accumulating the phase-corrected sample signals associated with the second group of symbols with the sample signals stored in the first buffer based on sample indices.

8. The wireless communication apparatus according to claim 2, wherein each symbol included in the first group of symbols and the second group of symbols is associated with different ground truth sequences, and the processing circuit is further configured to generate a correlation value based on the associated ground truth sequence for each sample signal included in the first group of symbols stored in the first buffer, accumulate the generated correlation value with a correlation value stored in the second buffer, and store the accumulated correlation values associated with the first group of symbols in the second buffer.

9. The wireless communication apparatus according to claim 8, wherein the processing circuit is further configured to:
estimate an accumulated phase offset associated with the first group of symbols based on the estimation data associated with the first group of symbols; and
correct the accumulated correlation values associated with the first group of symbols stored in the second buffer based on the estimated accumulated phase offset.

10. The wireless communication apparatus according to claim 8, wherein the processing circuit is further configured to:
estimate an individual phase offset for each of the second group of symbols based on the estimation data;
correct a phase of each sample signal included in the second group of symbols based on the individual phase offset;
generate correlation values of the phase-corrected sample signals based on ground truth sequences associated with the second group of symbols; and
store accumulated correlation values associated with the pilot signal in the second buffer, in which the accumulated correlation values are generated by accumulating correlation values of the phase-corrected sample signals with accumulated correlation values stored in the second buffer based on the sample indices.

11. The wireless communication apparatus according to claim 2, wherein the processing circuit estimates an individual phase offset for each of the second group of symbols based on the estimation data, and the individual phase offset is updated on each symbol of the second group of symbols based on a frequency offset estimated for each symbol of the second group of symbols.

12. The wireless communication apparatus according to claim 1, wherein the receiver is further configured to receive a synchronous signal associated with the pilot signal through the communication channel before receiving the pilot signal with an idle period between the synchronous signal and the pilot signal.

13. The wireless communication apparatus according to claim 12, wherein the idle period is a predetermined length of time, and a length of the idle period is longer than a length of the synchronous signal.

14. The wireless communication apparatus according to claim 1, wherein a phase offset for each of the first group of symbols and the second group of symbols included in the pilot signal is 180 degrees or less.

15. The wireless communication apparatus according to claim 1, wherein the channel estimation value comprises a Channel Impulse Response (CIR) value for the communication channel.

16. The wireless communication apparatus according to claim 15, wherein the CIR value comprises a first CIR value and a second CIR value based on the determined symbol boundary, and the first CIR value is associated with sample signals received before the symbol boundary and the second CIR value is associated with sample signals received after the symbol boundary.

17. An operating method of a wireless communication apparatus, comprising:
receiving a pilot signal including a first group of symbols and a second group of symbols through a communication channel;
determining a symbol boundary and estimation data associated with the first group of symbols based on the first group of symbols; and
determining a channel estimation value based on the second group of symbols, the symbol boundary, and the estimation data associated with the first group of symbols.

18. The method according to claim 17, wherein the determining the estimation data comprises:
storing sample signals associated with the first group of symbols in a first buffer;
calculating accumulated correlation values associated with the first group of symbols and storing the accumulated correlation values in a second buffer; and
calculating estimation data associated with the first group of symbols based on the accumulated correlation values associated with the first group of symbols stored in the second buffer, and the estimation data comprises at least one of an initial phase offset associated with the first group of symbols, an initial frequency offset associated with the first group of symbols, or the number of symbols included in the first group of symbols.

19. The method according to claim 18, wherein the determining the channel estimation value comprises:
estimating an accumulated phase offset associated with the first group of symbols based on the estimation data associated with the first group of symbols;
estimating an individual phase offset for each of the second group of symbols based on the estimation data associated with the first group of symbols;
correcting, based on the accumulated phase offset, accumulated sample signals generated by accumulating sample signals associated with the first group of symbols stored in the first buffer based on sample indices or by accumulating the accumulated correlation values associated with the first group of symbols stored in the second buffer; and
correcting a phase of each sample signal included in the second group of symbols based on the individual phase offset.

20. A wireless communication system comprising:
a first wireless communication apparatus configured to transmit a pilot signal; and
a second wireless communication apparatus configured to receive the pilot signal and a synchronous signal associated with the pilot signal,
wherein the second wireless communication apparatus comprises:
a receiver configured to receive the synchronous signal and the pilot signal through a communication channel; and
a processing circuit configured to determine a channel estimation value for the communication channel based on the received pilot signal,
wherein the receiver is further configured to receive the pilot signal after receiving the synchronous signal, with an idle period between the synchronous signal and the pilot signal, and
wherein the processing circuit is further configured to:
determine a symbol boundary and estimation data associated with a first group of symbols based on the first group of symbols included in the pilot signal; and
determine the channel estimation value based on a second group of symbols included in the pilot signal which is different from the first group of symbols, the symbol boundary, and the estimation data associated with the first group of symbols.
